(19) United States
(12) Patent Application Publication
(10) Pub. No.: US 2007/0267513 A1
(43) Pub. Date: Nov. 22, 2007

(54) Low profile fountain or water display

(76) Inventor: William A. Taylor, Galloway, OH (US)

Correspondence Address: Patrick P. Phillips;KREMBLAS, FOSTER, PHILLIPS & POLLICK, 7632 Slate Ridge Blvd., Reynoldsburg, OH, 43068, US

(21) Appl. No.: 11/435,061

(22) Filed: May 17, 2006

(51) Int. Cl. B05B 17/08

(52) U.S. Cl. 239/23; 239/17

(57) ABSTRACT

A water display for use within a container having a bottom surface and containing water. The water display has a pump, and a riser, with the pump positioned below the surface of the water. The pump has a discharge opening having conduit connected thereto. The riser is positioned on the bottom surface of the container and extends upwardly therefrom, with the pump being positioned on the upper surface of the riser. Preferably the riser also has pump retaining means. Each piece of horizontal conduit is engaged with a horizontal conduit support in contact with the bottom surface of the container. Each horizontal conduit support has formed therein a channel which retains horizontal conduit therein. Modified embodiments feature a plurality of vertical conduit. Another modified embodiment features at least one pair of vertical conduit spanned by an elevated horizontal conduit having at least one discharge opening therein.

### BACKGROUND OF THE INVENTION

1. Field of the Invention

This invention relates generally to decorative outdoor fountains and water displays, and even more particularly to such devices that require a low profile.

2. Description of the Related Art

This invention is directed to a low profile water display, such as a fountain, that can be used in the landscaping of a residential or commercial setting. Fountains have become increasingly popular due to their attractiveness in landscape design. The sound of naturally flowing water provides a desirable background noise, and the cascading or dancing of water often evokes thoughts of a more rural or rustic setting.

Many decorative fountains designed for outdoor use are quite substantial in size, requiring concrete or bricks in the fabrication of their foundation. However, it is believed that a market exists, in small commercial and most residential application, for a fountain or similar water display that is far smaller in size.

Attempts to design landscaping items that feature water include Ehrlich, U.S. Pat. No. 6,439,471, Taylor, U.S. Pat. No. 6,748,699, and Cramer, U.S. Pat. No. 5,718,379. However, aesthetic and structural drawbacks exist with many of these devices. It is thus apparent that the need exists for a water display that addresses the foregoing needs. Other objects and advantages of the invention will be apparent from the following description, the accompanying drawings and the appended claims.

### SUMMARY OF THE INVENTION

In accordance with the present invention, there is disclosed a water display for use within a container having a bottom surface and containing water, with the water display having a pump, and a riser, with the pump positioned below the surface of the water, and the pump having a discharge opening, with the discharge opening having conduit connected thereto. The riser is positioned on the bottom surface of the container and extends upwardly therefrom, with the riser having an upper surface located above the bottom surface of the container. The pump is positioned on the upper surface of the riser, with the riser also having pump retaining means.

The conduit includes horizontal conduit, with the horizontal conduit extending in a plane substantially horizontal to the surface of the water in the container, and each horizontal conduit is engaged with a horizontal conduit support. Each horizontal conduit support is adjacent to the bottom surface of the container. Each horizontal conduit support has a bottom surface, a top surface, and a channel, with the bottom surface positioned adjacent the bottom surface of the container, and with the channel extending downwardly from the top surface. The channel has a top edge adjacent the top surface, and the channel has a sidewall and a bottom, with the bottom of the channel located above (i.e. higher than) the bottom surface of the horizontal conduit support. The horizontal conduit is retained in the channel. At least one conduit support plate is secured to the horizontal conduit support. The conduit support plate has an aperture therein, the conduit passing therethrough.

The horizontal conduit support includes a first side surface and a second side surface, with the channel extending between the first side surface and the second side surface. The horizontal conduit support also includes at least one additional aperture, with each such aperture extending between the first side surface and the second side surface. The water display conduit includes vertical conduit, and in several embodiments of the invention, the vertical conduit is connected to the horizontal conduit, with each horizontal conduit support located between the pump and the vertical conduit. In one embodiment of the invention, the conduit includes a pair of vertical conduit, with the pair of vertical conduit each having a lower section connected to the horizontal conduit, and with the pair of vertical conduit each having an upper section connected to an elevated horizontal conduit, with the elevated horizontal conduit having a sidewall with at least one slot formed therein and extending generally in the direction of the longitudinal axis of the elevated horizontal conduit.

The pump retaining means includes a plurality of flanges extending upwardly above the upper surface of the riser. Each of the pump retaining means preferably includes a securing means that passes through the pump retaining means, with the securing means providing adjustment, so that each of securing means can be adjusted to contact the pump.

There is also disclosed a water display having an open-topped container for retaining water, a pump connected to conduit that discharges water, and a riser. The container has a sidewall and a bottom surface, with the riser being positioned on the bottom surface of the container and extending upwardly therefrom. The riser has an upper surface located above the bottom surface of the container, with the pump being positioned on the upper surface. The riser preferably has pump retaining means. The pump is positioned in the container at a point below the surface of the water to be retained in the container. The pump has a pump discharge opening having conduit connected thereto, with the conduit having at least one conduit discharge opening. In those embodiments using horizontal conduit, the horizontal conduit extends in a plane substantially horizontal to the surface of the water to be retained in the container, with each section of the horizontal conduit engaging a horizontal conduit support.

Each horizontal conduit support rests on the bottom surface of the container. Each horizontal conduit support has a bottom surface, a top surface, and a channel, with the bottom surface positioned adjacent the bottom surface of the container, and with the channel extending downwardly from the top surface. The channel has a top edge adjacent the top surface, and has a sidewall and a bottom, with the bottom of the channel located above the bottom surface of the horizontal conduit support. The horizontal conduit is retained in the channel. At least one conduit support plate is secured to the horizontal conduit support. The conduit support plate has an aperture therein, the conduit passing therethrough.

The horizontal conduit support also has a first side surface and a second side surface, with the channel extending between the first side surface and the second side surface, and with the horizontal conduit support also including at least one additional aperture which extends between the first side surface and the second side surface. In those embodiments where there is more than one section of vertical conduit, the vertical conduit is connected to the horizontal conduit, with each horizontal conduit support located between the pump and the vertical conduit.

The primary objective of this invention is to provide a water display that can be easily installed in its desired locale, especially in a residential setting.

Another objective of this invention is to provide such a water display which is relatively easy to fabricate.

Still another objective of this invention is to provide a water display having a design that can be modified easily.

Other objects and advantages of the invention will be apparent from the following description, the accompanying drawings and the appended claims.

### BRIEF DESCRIPTION OF THE DRAWINGS

FIG. 1 is a schematic view of a water display system made in accordance with the present invention showing the system in its operative condition.

FIG. 2 is a top plan view of the riser component of the water display system.

FIG. 3 is a partial schematic view similar to FIG. 1 of a modified embodiment of the invention.

FIG. 4 is an exploded perspective view of the horizontal conduit support component.

FIG. 5 is a partial schematic view similar to FIG. 1 of a further modified embodiment of the invention.

FIG. 6 is a top plan view of the modified embodiment of the invention disclosed in FIG. 5.

FIG. 7 is a partial schematic view similar to FIG. 3, but of a further modified embodiment of the invention.

In describing the preferred embodiment of the invention which is illustrated in the drawing, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

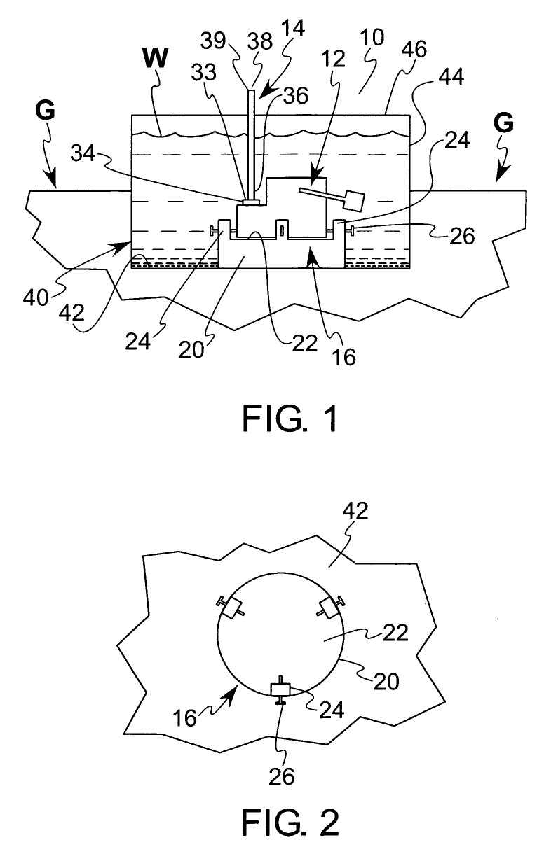

Having reference to the drawing, attention is directed to FIG. 1, which discloses a water display made in accordance with the invention designated generally by the numeral 10. It can be fabricated from a variety of materials well known in the manufacture of outdoor fountains and water displays.

Having reference to FIG. 1, the display 10 comprises a sump pump 12 having a motor, pump, float, and access opening to permit water to enter the pump, all of which are well known in the art of sump pumps. The display also includes conduit 14 and a riser 16.

It can be appreciated by comparing FIGS. 1 and 2 that the riser 16 features a base portion 20 shown as being circular although other shapes could be utilized, with the riser having an upper surface 22, and pump retaining means 24. Although this pump retaining means could take the form of recesses in the upper surface 22, in the preferred embodiment of the invention, the pump retaining means features a plurality of raised members similar to rectilinear blocks around the periphery of the upper surface 22. In the drawings, three pump retaining means or side braces 24 are shown, but there could be a larger or smaller number. To further assist in preventing the pump 12 from moving from atop the riser 16, securing means 26 such as screw-threaded bolts are shown extending through each pump retainer. By tightening or loosening of the bolts, all of them can be made to contact the exterior surface of the pump to secure the pump in place.

FIG. 1 discloses that the sump pump 12 has a reducer 33 secured at the pump discharge opening 34 due to the size discrepancy between a normal sump pump discharge opening and the conduit typically used with this invention, namely ½″ to ¾″ PVC pipe. The conduit shown in the embodiment of FIG. 1 is vertical conduit having a conduit bottom or first end 36 and a conduit top or second end 38 where a conduit discharge opening 39 is located which can utilize any number of well known fountain spray heads.

The display 10 is housed in a container 40 having a lower surface 42, sidewall 44, and top edge 46. In the preferred embodiment of the invention, the sidewall is 18″ high and the lower surface 42 is located approximately 9″ below ground level G, such that the water level W is 1-3″ below the top edge 46.

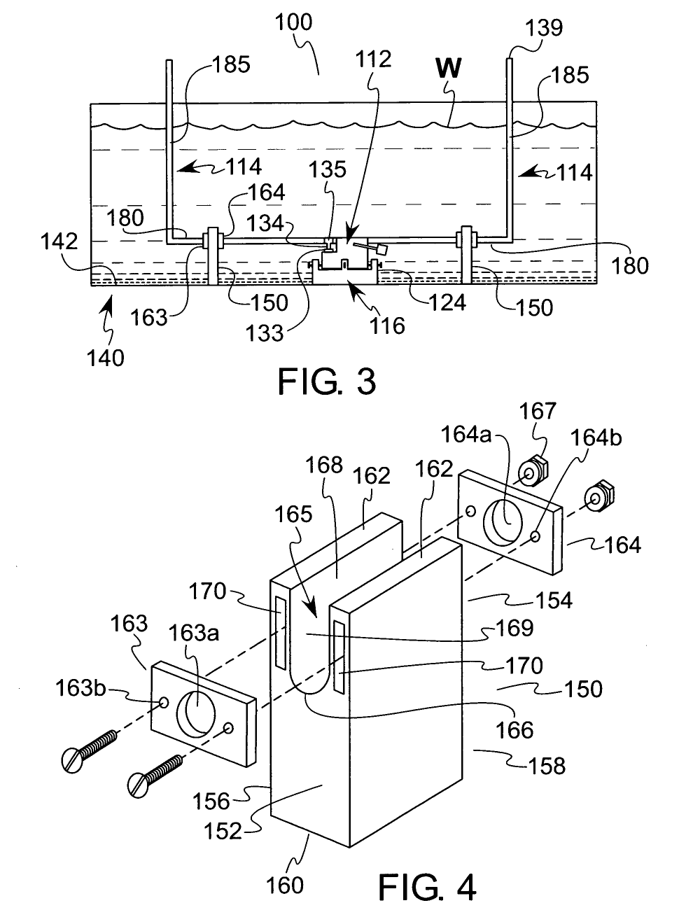

A modified embodiment of the invention is disclosed in FIG. 3. This embodiment also makes use of a sump pump 112, conduit 114, and a riser 116, with the riser including a pump retainer 124. The sump pump 112 has a reducer 133 at the discharge opening 134 of the sump pump. A hydraulic connector 135 of the type well known in pipes is used to direct the flow of water from the sump pump into the designated number of conduits, shown in FIG. 3 as two through the use of a T-connector. One end of the conduit connects to the connector 135, with the other end of the conduit having a conduit discharge opening 139 which can utilize any number of well known fountain heads. The display 100 is housed in a container 140 having a lower surface 142 having similar dimensions to the embodiment disclosed in FIG. 1, although the size of the surface area of the lower surface can vary depending upon design choice.

One component utilized in the embodiment of the invention shown in FIG. 3, but not in FIG. 1, is a horizontal conduit support 150, which is shown in an enlarged and exploded form in FIG. 4. The support 150 has a first side surface 152 shown as a front face, a second side surface 154 shown as a rear face, a third side surface 156 shown as a first sidewall, and a fourth side surface 158 shown as a second sidewall. The support 150 also has a bottom surface 160 and a top surface 162. A vertically depending channel 165 in the support 150 has a bottom 166 and extends upwardly until terminating at top edge 168.

The channel also has a channel sidewall 169 that extends from the bottom 166 of the channel to the top surface 162. The horizontal conduit support 150 can have one or more support apertures formed therein that extend completely from the front to the rear surface thereby minimizing the effect of water current on the conduit support. At least one conduit support plate 163 is secured to a first side surface 152 of the horizontal conduit support 150, and preferably a second conduit support plate 164 is secured to the second side surface 154. The conduit support first plate 163 is shown as having a central aperture 163a dimensioned such that the horizontal conduit can pass therethrough. Similarly, the conduit support second plate 164 is shown as having a central aperture 164a dimensioned such that the horizontal conduit can also pass therethrough. Each conduit support plate 163, 164 is secured to the horizontal conduit support by appropriate fastening means 167 which pass through conduit support apertures 170 and the fastening means apertures 163b, 164b respectively.

Finally, the conduit 114 used in this embodiment includes horizontal conduit 180 which is retained in the channel of the conduit support and vertical conduit 185. The horizontal conduit extends outwardly from the pump and the vertical conduit extends upwardly from the horizontal conduit to a point above the water level W.

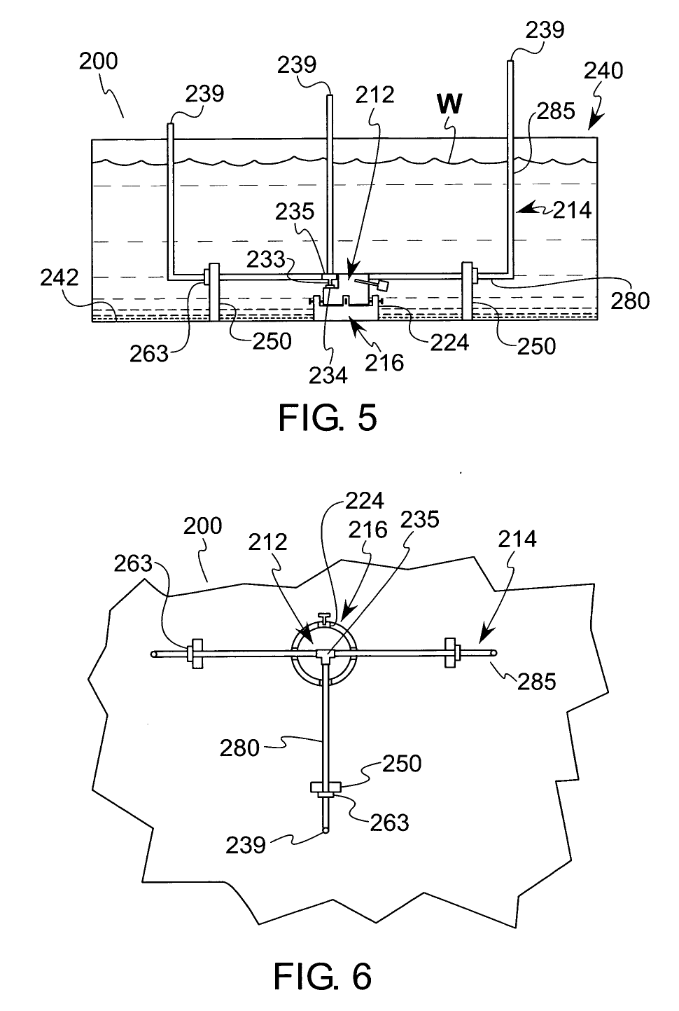

A further modified embodiment 200 of the invention can be appreciated from a comparison of FIGS. 5-6. This embodiment also makes use of a sump pump 212, conduit 214, and a riser 216, with the riser including a pump retainer 224. The sump pump 212 has a reducer 233 at the discharge opening 234 of the sump pump. A hydraulic connector 235 of the type well known in pipes is used to direct the flow of water from the sump pump into the designated number of conduits, shown in FIGS. 5-6 as three through the use of a suitable connector. One end of the conduit connects to the connector 235, with the other end of the conduit having a conduit discharge opening 239 which can utilize any number of well known fountain heads. The display 200 is housed in a container 240 having a lower surface 242 having similar dimensions to the embodiment disclosed in FIG. 1, although the size of the surface area of the lower surface can vary depending upon design choice.

This embodiment of the invention also features a horizontal conduit support 250 shown in FIGS. 5-6. The support 250 has the same structure as the horizontal conduit support 150 shown in FIGS. 3-4, although as shown in FIGS. 5 and 6 it should be appreciated that only one conduit support plate 263 is being used with each horizontal conduit support. However, two conduit support plates could be used just as shown in the previous embodiment. The conduit 214 used in this embodiment include horizontal conduit 280 which is retained in the channel of the conduit support and vertical conduit 285. The horizontal conduit extends outwardly from the pump and the vertical conduit extends upwardly from the horizontal conduit to a point above the water level W.

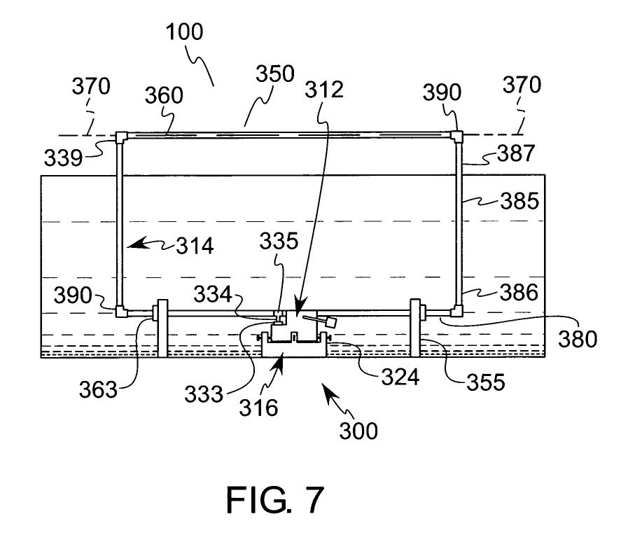

Still another modified embodiment of the invention is disclosed in FIG. 7. This embodiment 300 is similar to the one shown in FIG. 3, in the sense that it includes a sump pump 312, conduit 314, and a riser 316, with the riser including a pump retainer 324. The sump pump 312 has a reducer 333 at the discharge opening 334 of the sump pump. A hydraulic connector 335 of the type well known in pipes is used to direct the flow of water from the sump pump into the designated number of conduits, shown in FIG. 7 as two through the use of a T-connector although this number could vary depending upon the ultimate design of the water display. One end of the conduit connects to the connector 335, with the other end of the conduit 339 being connected to an elevated horizontal conduit 350 that connects with the other vertical conduit end 339.

Once again, horizontal conduit supports 355 has the same structure as the horizontal conduit support 150 shown in FIGS. 3-4, although as shown in FIG. 7 it should be appreciated that only one conduit support plate 363 is being used with each horizontal conduit support 355. However, two conduit support plates could be used just as shown in the first embodiment.

The horizontal conduit 380 thus extends from the connector 335 to the vertical conduit 385 where it enters the lower section 386 of the vertical conduit. The upper section 387 of the vertical conduit 385 connects to the elevated horizontal conduit 350. The elevated horizontal conduit 350 has formed therein at least one discharge opening 360.

In the preferred embodiment of the invention, this discharge opening is a slot extending in the direction of the longitudinal axis 370 of said elevated horizontal conduit, which would result in the water flowing through the slot having an appearance similar to a waterfall. By having the elevated horizontal conduit incorporate slots substantially all of the way along its length, the display would appear to be a larger waterfall. The width of the slot would adjust the amount of water to be discharged, thus providing for a thicker or thinner sheet of water. Alternatively, the discharge openings could be a plurality of small apertures to give the appearance of falling raindrops. The junctions of the various vertical and horizontal conduit pieces could utilize connectors 390, unless all of the conduit pieces are provided for installation as a unitary structure. These connectors 390 could be utilized in the other modified embodiments as well.

The water display of this invention provides a decorative display that is easy to fabricate and install in an operative location. Additionally, the display can be installed in existing containers or sold as a complete system.

While the form of apparatus herein described constitutes a preferred embodiment of the present invention, it is to be understood that the invention is not limited to this precise form of apparatus and that changes may be made therein without departing from the scope of the invention which is defined in the appended claims.

What is claimed is:

1. A water display for use within a container having a bottom surface and containing water, said water display comprising
a pump, said pump positioned below the surface of the water, said pump having a pump discharge opening, said discharge opening having conduit connected thereto, said conduit having at least one discharge opening, and
a riser, said riser positioned on the bottom surface of the container and extending upwardly therefrom, said riser having an upper surface located above the bottom surface of the container, said pump positioned on said upper surface, said riser having pump retaining means.

2. The water display according to claim 1 wherein said conduit includes horizontal conduit, said horizontal conduit extending in a plane substantially horizontal to the surface of the water in the container, each of said horizontal conduit engaged with a horizontal conduit support.

3. The water display according to claim 2 wherein each horizontal conduit support is attached to the bottom surface of the container.

4. The water display according to claim 2 wherein said horizontal conduit support has a bottom surface, a top surface, and a channel, said bottom surface positioned adjacent the bottom surface of the container, said channel extending downwardly from said top surface, said channel having a top edge adjacent the top surface, said channel having a sidewall and a bottom, said bottom of said channel located above said bottom surface of said horizontal conduit support, said horizontal conduit retained in said channel.

5. The water display according to claim 4 wherein said horizontal conduit support includes a first side surface and a second side surface, said channel extending between said first side surface and said second side surface, said horizontal conduit support also including at least one additional aperture, said aperture extending between said first side surface and said second side surface.

6. The water display according to claim 2 wherein said conduit includes vertical conduit, said vertical conduit connected to said horizontal conduit, each said horizontal conduit support located between said pump and said vertical conduit.

7. The water display according to claim 2 wherein said conduit includes a pair of vertical conduit, said pair of vertical conduit each having a lower section connected to said horizontal conduit, said pair of vertical conduit each having an upper section connected to an elevated horizontal conduit, said elevated horizontal conduit having a sidewall with at least one discharge opening formed therein.

8. The water display according to claim 1 wherein said pump retaining means includes a plurality of flanges extending upwardly above said upper surface of said riser.

9. The water display according to claim 8 wherein each of said pump retaining means includes a securing means that passes through a pump retaining means, said securing means being adjustable, each of said securing means being adjusted to contact said pump.

10. A water display, said water display comprising,
an open-topped container for retaining water, said container having a sidewall and a bottom surface,
a pump, said pump positioned in said container at a point below the surface of the water to be retained in said container, said pump having a pump discharge opening, said discharge opening having conduit connected thereto, said conduit having at least one conduit discharge opening, and
a riser, said riser positioned on the bottom surface of the container and extending upwardly therefrom, said riser having an upper surface located above the bottom surface of the container, said pump positioned on said upper surface, said riser having pump retaining means.

11. The water display according to claim 10 wherein said conduit includes horizontal conduit, said horizontal conduit extending in a plane substantially horizontal to the surface of the water when in the container, each of said horizontal conduit engaged with a horizontal conduit support.

12. The water display according to claim 11 wherein each horizontal conduit support is attached to the bottom surface of the container.

13. The water display according to claim 12 wherein said horizontal conduit support has a bottom surface, a top surface, and a channel, said bottom surface positioned adjacent the bottom surface of the container, said channel extending downwardly from said top surface, said channel having a top edge adjacent the top surface, said channel having a sidewall and a bottom, said bottom of said channel located above said bottom surface of said horizontal conduit support, said horizontal conduit retained in said channel.

14. The water display according to claim 13 wherein said horizontal conduit support includes a first side surface and a second side surface, said channel extending between said first side surface and said second side surface, said horizontal conduit support also including at least one additional aperture, said aperture extending between said first side surface and said second side surface.

15. The water display according to claim 11 wherein said conduit includes vertical conduit, said vertical conduit connected to said horizontal conduit, each said horizontal conduit support located between said pump and said vertical conduit.

16. The water display according to claim 11 wherein said conduit includes a pair of vertical conduit, said pair of vertical conduit each having a lower section connected to said horizontal conduit, said pair of vertical conduit each having an upper section connected to an elevated horizontal conduit, said elevated horizontal conduit having a sidewall with at least one discharge opening formed therein.

17. The water display according to claim 10 wherein said pump retaining means includes a plurality of flanges extending upwardly above said upper surface of said riser.

18. The water display according to claim 17 wherein each of said pump retaining means includes a securing means that passes through a pump retaining means, said securing means being adjustable, each of said securing means being adjusted to contact said pump.

19. The water display according to claim 7 wherein at least one discharge opening is a slot extending in the direction of the longitudinal axis of said elevated horizontal conduit.

20. The water display according to claim 16 wherein at least one discharge opening is a slot extending in the direction of the longitudinal axis of said elevated horizontal conduit.
